(19) United States
(12) Patent Application Publication
(10) Pub. No.: US 2012/0154379 A1
(43) Pub. Date: Jun. 21, 2012

(54) SYSTEM FOR DISPLAYING A TRADITIONAL FINANCIAL STATEMENT IN A NON-VERBAL MANNER

(75) Inventor: Peter Lawrence FRAMPTON, Washington, DC (US)

(73) Assignee: COMES ALIVE INTERNATIONAL, INC., Road Town (VG)

(21) Appl. No.: 13/161,065

(22) Filed: Jun. 15, 2011

Related U.S. Application Data
(60) Provisional application No. 61/423,910, filed on Dec. 16, 2010.

(51) Int. Cl. G06T 15/00; G06T 11/00

(52) U.S. Cl. 345/419; 345/467

(57) ABSTRACT

Disclosed is a system for comparatively displaying values using non-verbal means. The system is recorded on a non-transitory medium. Included in the system is an identification component that identifies a first metric that has a first value and a second metric that has a second value. A processor selects a respective first and second non-verbal symbol to represent each of the first metric and the second metric and calculates a size of each non-verbal symbol based on the values of the first and second metrics. A high definition output means displays the non-verbal symbols. Each of the non-verbal symbols has a single dimension that is divisible by a single denominator. The processor also creates and displays on the high definition output means, a non-verbal reference symbol and a reference value associated with the reference symbol that represents the relationship of the first and second values to the size of the non-verbal symbols.

This application is a non-provisional application of U.S. Provisional Application No. 61/423,910, which was filed on Dec. 16, 2010 and is hereby incorporated by reference.

### FIELD OF THE INVENTION

Disclosed is a method and means for representing business metrics using non-verbal means.

### BACKGROUND

A financial statement is a report that quantitatively describes the financial health of an entity. Financial statements may be used for different purposes. Business owners and managers require financial statements to make important business decisions that affect the business's continued operations. Financial analysis is then performed on these statements to provide management with a more detailed understanding of the figures contained therein. These statements are also used as part of management's annual report to stockholders.

Employees also need these reports in making collective bargaining agreements with management, in the case of labor unions or for individuals in discussing their compensation, promotion and rankings. Prospective investors make use of financial statements to assess the viability of investing in a business. Vendors who extend credit to a business require financial statements to assess the creditworthiness of the business. Financial analyses are often used by investors and are prepared by financial analysts, thus providing them with the basis for making investment decisions. Financial institutions and lending companies use financial statements to decide whether to grant a company with fresh working capital or extend debt securities to finance expansion and other significant expenditures. Government entities need financial statements to ascertain the propriety and accuracy of taxes and other duties declared and paid by a company.

Managers of various enterprises need to have a good understanding of these accounting principles and their related bookkeeping concepts. Moreover, it is important that their understanding not be limited to knowledge of just the dry mechanics of the topic, for example, the technical terms “debits,” “credits,” “financial statements,” etc. Rather, it should also include a natural and intuitive understanding of the meaning behind the concepts. In this way, the various accounting terms could be meaningfully related to fundamental day-to-day management concerns, such as cash flow and profits, for example. This would allow for better management decisions.

The objective of financial statements is to provide information about the financial position, performance and changes in financial position of an enterprise that is useful to a wide range of users in making economic decisions. Financial statements should be understandable, relevant, reliable and comparable. However, due to the amount and size of information that is maintained on a financial statement, the ultimate message of the financial statement can become confusing. It is often difficult for even a skilled person in accounting to make conclusions from a traditional financial statement.

In practice, while there are many books and courses on the subject, the principles of accounting and basic business concepts are still not well or widely understood. The problem is that a good understanding of how money flows in and out of a business requires an appreciation of the interrelationship between different accounts and bookkeeping entries. These are technical, abstract concepts that can be difficult to convey using books or traditional lecture methods, which generally require a student to keep a number of abstract concepts, functions, and sums organized in his or her head.

As a result, accounting knowledge tends to be concentrated among those who have dedicated extensive study time to the topic, such as for example, financial executives. Managers of other areas of an enterprise, lower-level employees, and entrepreneurs may therefore lack the conceptual understanding of accounting principles that would optimize their contribution.

U.S. Patent Application Publication No. 2002/0164561 to Joffe discloses a method of teaching financial management of an enterprise using pre-printed financial statements and a set of monetary markers that can be used to represent the impact of transactions on the financial statements. It is rules-based, meaning that the accounting rules that underpin accounting literacy are all hard-coded into the pre-printed materials. This means that the student learns how to use the provided rules according to the provided examples, but will be unable to generalize the use of those rules to other situations not contemplated by the method. Joffe uses monetary markers (0034) “that may be likened to common paper currency.” Joffe provides various instructional boxes or messages to provide convenient reminders or assistance to the student.

### SUMMARY

What many business managers simply want to know is: whether what is coming in to the business is greater than what is going out of the business. If not, why? The presently disclosed system and method provides a simplified way of knowing what is coming in and what is going out of a business.

Disclosed is a system that comparatively displays business metrics and values using non-verbal means. The system is recorded on a non-transitory medium and includes an identification component, a processor, and a high definition output means. The identification component identifies a first metric that has a first value and a second metric that has a second value. The processor selects a respective first and second non-verbal symbol to represent each of the first metric and the second metric and the processor calculates a size of each non-verbal symbol based on the values of the first and second metrics. The high definition output means displays the non-verbal symbols. Each of the non-verbal symbols has a single dimension that is divisible by a single denominator.

The processor also creates and displays on the high definition output means a non-verbal reference symbol and a reference value associated with the reference symbol that represents the relationship of the first and second values to the size of the non-verbal symbols. The output means can be bifurcated depicting on a first side thereof a use field and depicting on a second side thereof a source field. Each field would include one of the first metric or the second metric, the first metric would represent an asset and the second metric would represent a liability. The assets and liabilities would be obtained from a traditional financial statement.

The form of the non-verbal symbol can be one or a combination of a circle, an oval, an asymmetric figure, a square, a triangle, a three-dimensional figure and a polygon. The non-verbal symbol can be a real-life tangible object, a computer screen icon or any other form capable of representing a value. If used as a computer screen icon, the icon can have drill down capabilities to show information about a business metric, i.e., profit, equity, assets, liabilities, profit per employee, market capitalization, return on assets, earnings per share, price, price per and earnings. Any of these metrics can be added using a third non-verbal symbol. The high definition output means is one or a combination of a display screen, a tactile device, an olfactory device, a print-out, and a speaker.

A method of comparatively displaying values using non-verbal means, would include the steps of identifying a first metric having a first value and a second metric having a second value; selecting a respective non-verbal symbol to represent each of the first metric and the second metric; calculating a size of each non-verbal symbol based on the values of the first and second metrics; displaying on a high definition output means the non-verbal symbols, each of the non-verbal symbols having a single dimension that is divisible by a single denominator; and creating and displaying on the high definition output means, a non-verbal reference symbol and a reference value associated with the reference symbol that represents the relationship of the first and second values to the size of the non-verbal symbols.

### BRIEF DESCRIPTION OF THE DRAWINGS

FIG. 1 shows a traditional accounting balance sheet;

FIG. 2 shows a traditional accounting income statement;

FIG. 3 shows an accounting storyboard with entries represented numerically;

FIG. 4 shows an accounting storyboard with entries represented non-verbally;

FIG. 5 shows a scale non-verbal symbol; and

FIG. 6 shows a physical three-dimensional model of a financial statement.

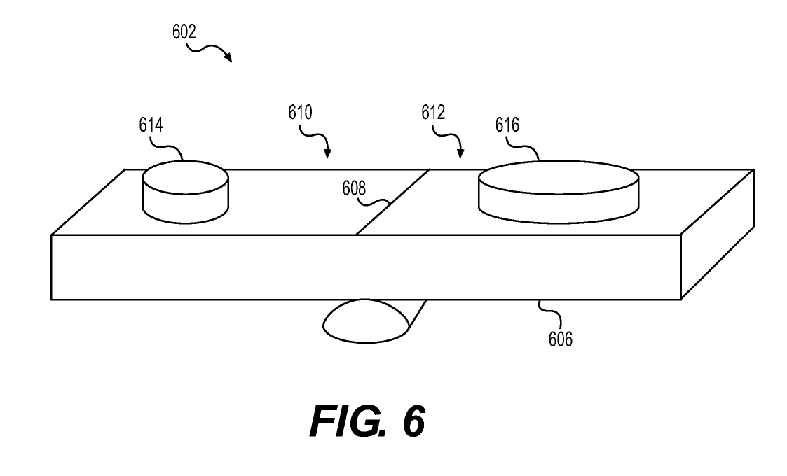

### DETAILED DESCRIPTION OF THE EMBODIMENTS

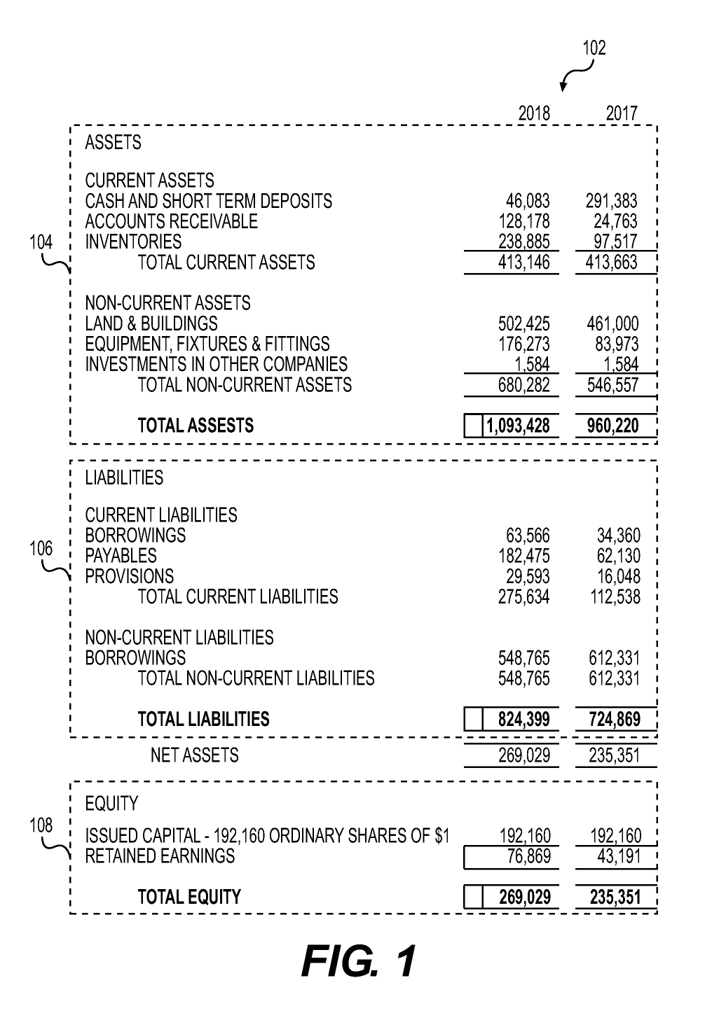

FIG. 1 shows a traditional balance sheet 102 that has a list of assets 104 and liabilities 106. Each asset and each liability has a number value associated with it. For example, in this figure, an “accounts receivable” entry is listed as an asset having a value of $128,178 and a “borrowings” entry is listed as a liability having a value of $63,566 (for discussion purposes, all monetary amounts provided in this disclosure will be in dollars; however, a person having ordinary skill in the art will understand that the disclosed system can be used with any currency). “Equity” 108 is also shown in this figure and has a value equal to assets minus liabilities.

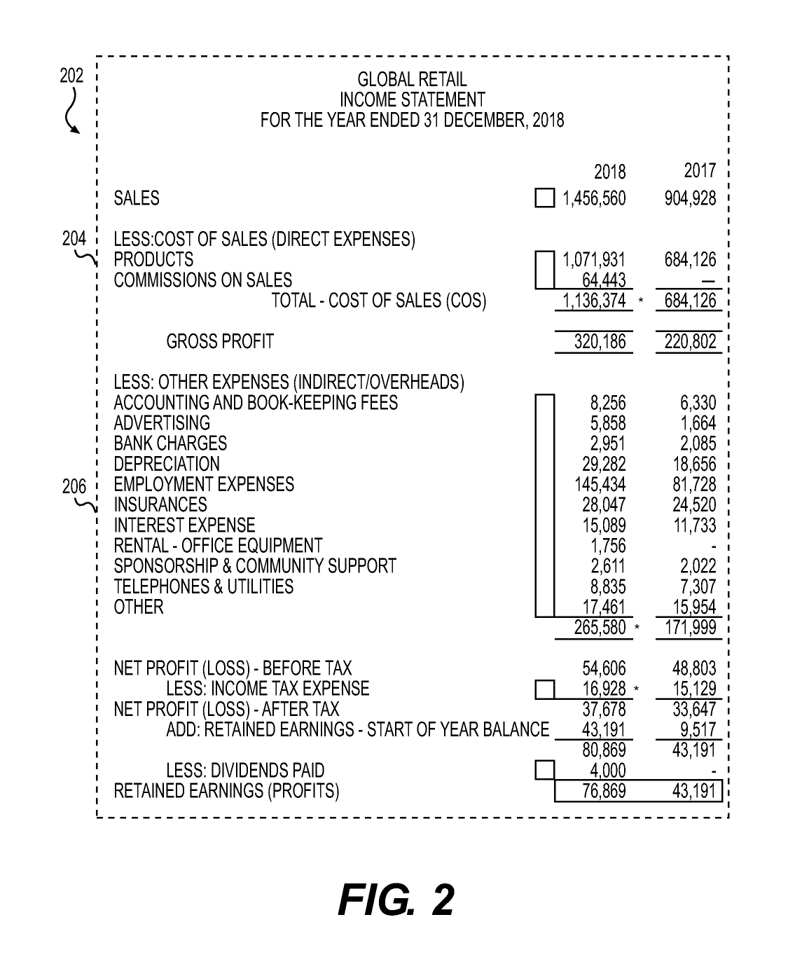

FIG. 2 shows a traditional income statement 202 that shows a variety of business metrics such as profits 204 and losses 206. Income gained as a result of a sale, a plurality of sales or any other income generating activity makes up profits. In FIG. 2, the amount of sales in the sample income statement is listed as sales ($1,456,560) minus the total cost of sales ($1,136,374).

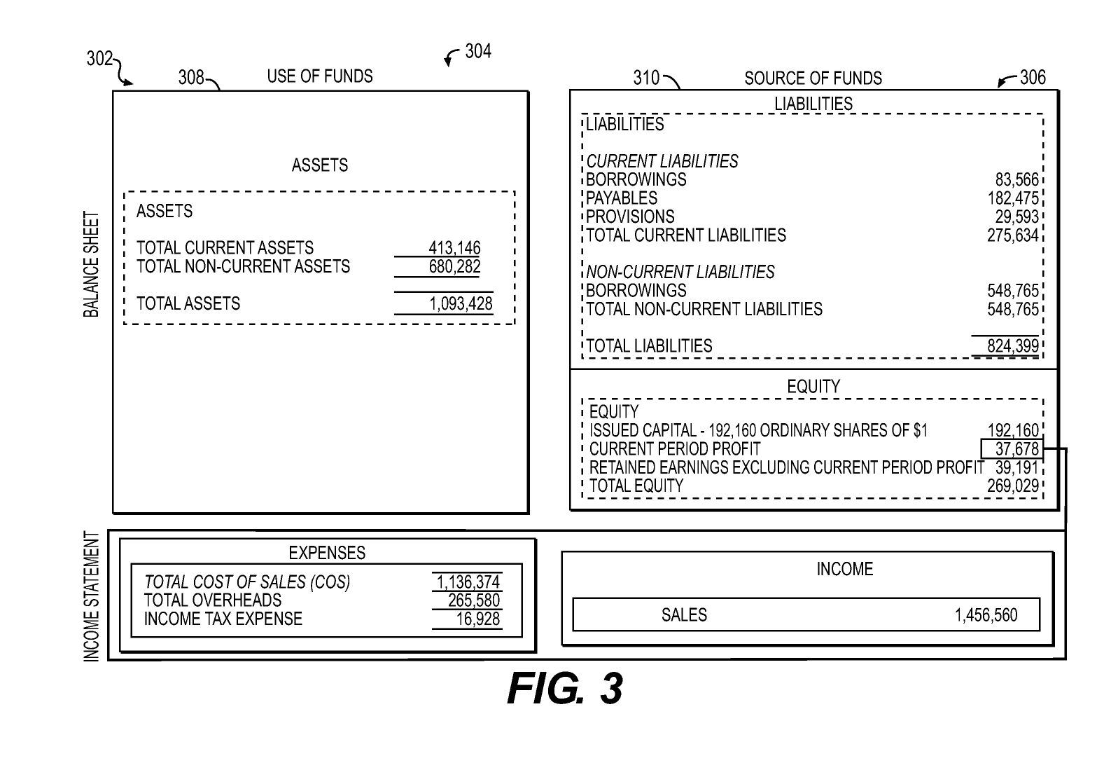

With reference to FIG. 3, values of a traditional financial statement can be shown on a non-verbal accounting storyboard. The values are manually entered into a system or processor running a program directed toward the disclosed method; they can be transferred from an electronic financial statement; or they can be OCR'd (optical character recognition) into the present system through scanning a paper statement. A color accounting storyboard 302 as described in U.S. Pat. No. 7,736,148 and U.S. Patent Application No. 12/222,988, each of which is incorporated herein by reference, is shown in FIG. 3. A storyboard can be configured in any way that is useful to a user. In this example, the storyboard 302 includes a use of funds column 304 (alternatively referred to as “use column”) and a source of funds column 306 (alternatively referred to as “source column”). Each column 304 and 306 is represented by a non-verbal symbol. In this embodiment, the use column 4 is represented by a first color 308 and the source column 306 is represented by a second color 310. The actual colors used in the system are arbitrary. Color 308 represents “debit” and color 310 represents “credit.” Each color, 308 and 310, can be replaced by two different types of patterns, two different types of paper stippling, sounds, etc. to represent the two sides of the funding story.

The color accounting storyboard 302 of FIG. 3 includes verbal values and is essentially a combination of the balance sheet and income statement of FIGS. 1 and 2. The data has been reorganized to show where it falls on a storyboard. At this point in the transformation of traditional business metrics into a non-verbal comparative representation, the verbal form of the entries is still present on the storyboard. For example, the values of each asset and expense are shown in the use of funds column 308 and the values of each liability and income generator are shown in the source of funds column 310.

This depiction of the storyboard with verbal entries is shown only to provide an understanding of the steps involved in the transformation from a traditional financial statement into a non-verbal representation of the traditional financial statement. In practice, the disclosed system can be transformed directly from the financial statement into the non-verbal representation of the financial statement. A user of the disclosed system will have the option of viewing a traditional financial statement, the non-verbal representation of the financial statement or the intermediary version of the financial statement as shown in FIG. 3.

One particular feature of the present subject matter is the ability of the system to recognize what kind of storyboard is necessary for a proper understanding of the underlying information. For example, the balance sheet style story board of FIG. 3 is not always the best depiction of the underlying information. Other circumstances would require different story board views.

In use, the system would have a look up table stored on a non-transitory medium. The look up table would include keywords that are typically related to a particular type of report. The system would identify as many keywords from the original sheet, i.e., from the business metric page or balance sheet page, as possible and then use those keywords to determine which report type is most likely to be the one needed by the user. The system would then suggest a group of possible report formats to the user. The user could then confirm or ignore the suggestions. If the suggestions are ignored, the search would stop or the user could request further search at which time, the system would then narrow down the search of the look-up table to those items that were not included in the results that were previously provided to the user.

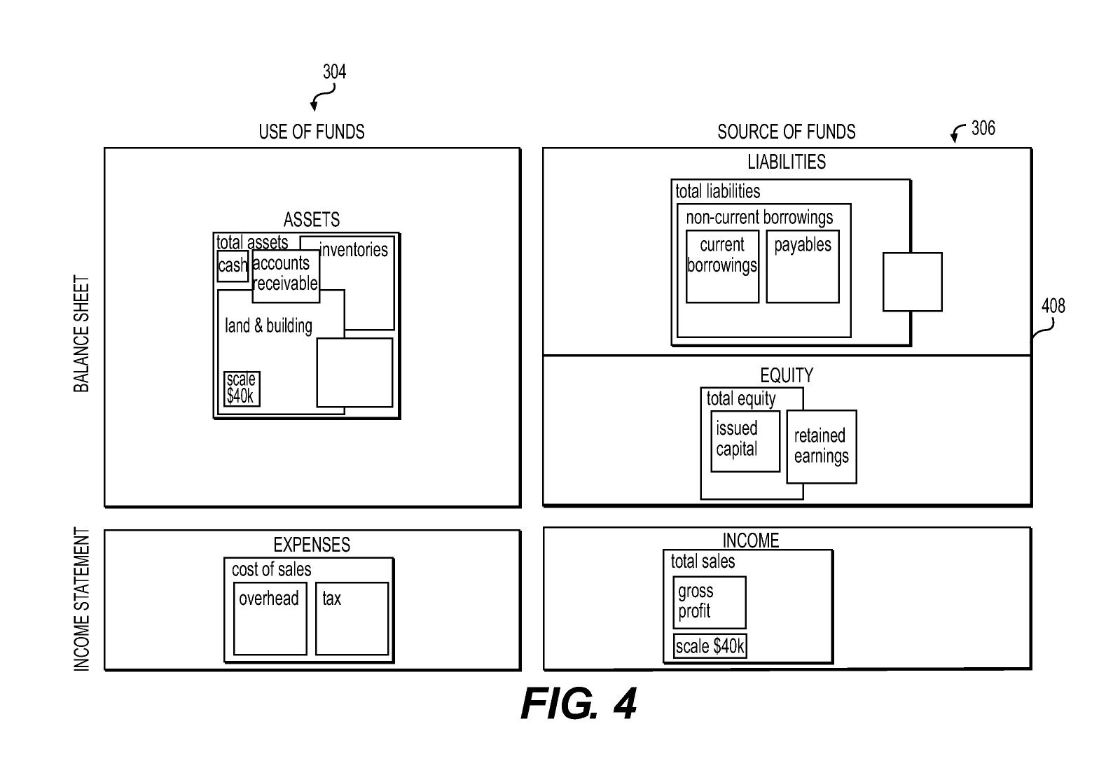

As shown in FIG. 4, the entries on a storyboard are transformed into objects that show value in a non-verbal manner. For example, equity is shown in FIG. 4 as a square 408 having a particular size that is representative of an underlying value. Each entry is translated into a non-verbal form by any of a number of equations, which would be selected depending on the form of the non-verbal symbol that is chosen. For example, if a square is chosen, the equation that will be used is one in which the resulting area of the square is in proportion to the amount of the entry. One equation would be to take the square root of the entry and make a length of each side of the square an equivalent factor of the square root. As all entries are subject to the same equation, the size of each square that represents a respective entry would be proportional to the size of the entry. If the non-verbal object is a circle, then the area would be the square root of the entry multiplied by two and then multiplied again by pi (3.1416). Alternatively, square roots need not be taken; for example, the actual amount of the entry can be used as the length of the side of a square or as the length of the radius of a circle.

Other non-verbal symbols include sounds, a color scale, a fragrance, a texture. With respect to a color scale, a fragrance or a texture, tables having relationships between values and non-verbal depictions can be stored on the system's non-transitory medium. In the case of a color scale, the value of the highest entry would be associated, for example, with the highest visible wavelength of visible color and the value of the lowest entry would be associated with the lowest wavelength of visible color. In the case where a financial statement is updated to include a value higher than the previously highest value, then that previously highest value color pairing on the look-up table would be replaced with the new highest value and the previous highest value would be reassigned to another color.

A similar table can be used with respect to sound and texture. An entry value that is associated with sound can be assigned a particular type of sound, i.e., a piano key, a whistle, breaking glass, etc. Alternatively, the length or intensity of sound can be varied based on the amount of an entry value—the higher the value, the longer the sound. An entry value that is associated with a texture can be assigned a certain roughness or configuration. For example, something similar to various grit sand papers can be used to represent different entry value ranges. The coarseness of the paper can be adjusted corresponding to the varying value of the entry.

This system can be configured to include an output system that physically creates the chosen non-verbal symbol. For example, a paper stippler would create surfaces with smoother or rougher textures depending on the value represented. A paper stippler would be especially useful for blind businesspersons. Or a printer that would normally deposit ink on a page would be configured to deposit a particular scent. The intensity of the scent or the choice of scent would be varied based on the underlying value of the business metric. Another alternative to a physical representation of the non-verbal symbol is using Lego® type blocks to create a three-dimensional structure. Debits would be represented by adding more blocks to a structure and credits would be represented by removing blocks from a structure. This can be done physically with the computer directing a user where to place each block, or it could be done virtually with the user seeing the computer placing the blocks in a structure that is represented on a screen.

Alternatively, a representative structure 602 can be used as a balanced three dimensional structure, which is constructed out of components representing entries on a financial statement. The structure would include a base having a fulcrum 604, a supporting structure 606 overlying the fulcrum 604 and a center dividing line 608 for dividing the supporting structure 606 into a first side 610 and a second side 612. A use object 614 would be placed on the first side 610 of the supporting structure 606 and a source object 616 would be placed on the second side 612 of the supporting structure 606 when the use object is placed on the first side of the supporting structure. The size of the use and source objects correspond to use and source entries on a balance sheet and the weight of the use and source objects are adjustable based on the size of the respective use and source entries on the balance sheet. Proper placement of both use and source objects on the supporting structure at the same time would result in the supporting structure being level about its' fulcrum. The source object can be a liability sub-block or an equity sub-block. The equity sub-block can be an income sub-block or an expense sub-block.

The system includes a drill down feature, which can show what the non-verbal symbol represents or, if the system is displaying a financial statement using verbiage, what each entry represents. For example, the origination of what can be represented, i.e., the story each non-verbal symbol or entry has. In this manner, each non-verbal symbol can have a sub-non-verbal symbol that represents some type of cost, i.e., man hours necessary to operate equipment, associated maintenance costs; depreciation, etc. Not only can the specifics about the asset be displayed by clicking on or rolling over the entry or non-verbal symbol, the asset can be linked to multiple programs.

One entry might need to be shown on a number of different financial statements through hyperlinking or some other means. If multiple departments within an organization need to show a single piece of equipment on two different financial statements, that single piece of equipment can potentially be shown as an asset on one statement and a liability on another or it can be shown as an asset (or a liability) on both statements.

Other information, such as payment history for assets or payoff amounts for liabilities can be shown as a drill-down feature. Traditionally, assets are generally listed based on how quickly they will be converted into cash. These types of assets are commonly referred to as “current” assets. A good example of a current asset is inventory. These items can be labeled differently from items that cannot be converted into cash as quickly. “Noncurrent” assets are things a company does not expect to convert to cash within one year or that would take longer than one year to sell. An example of noncurrent assets are those assets used to operate the business but that are not available for sale, such as trucks, office furniture and other property. Comparisons can be made between different year's earnings as well

Similarly, liabilities are generally listed based on their due dates. Liabilities are said to be either current or long-term. Current liabilities are obligations a company expects to pay off within the year. Long-term liabilities are obligations due more than one year away.

A useful tool in helping to interpret the value of each of the squares is a scale square that should be associated with a value. For example, a one inch by one inch square would represent one dollar, ten thousand dollars, ten million dollars, etc. As such, someone using this system would know that a square that is roughly two square inches would represent, in this example, two dollars, twenty thousand dollars, or twenty million dollars. It is not necessary that the square be a perfect square or even a square at all; any shape is perfectly acceptable as long as the area of the shape reflects the ratio between the value of the asset or liability and other asset or liability values.

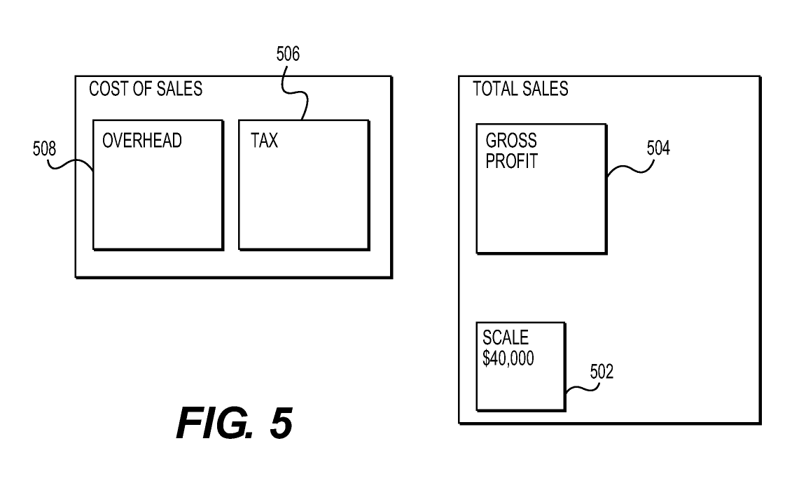

As shown in FIG. 5, a scale non-verbal symbol 502 is provided to give a user a reference value for the values represented by each of the non-verbal symbols 504, 506 and 508. The scale non-verbal symbol 502 can be hidden and called upon at any time to provide the user with a reference for determining underlying entry values of the representative non-verbal symbols. The scale non-verbal symbol 502 is either set by the user or is set automatically. The actual size of the scale non-verbal symbol is constant; however, the numerical value that the size represents will change (either if prompted by the user or automatically by the system). For the size of the scale non-verbal symbol to be set automatically, an acceptable range, i.e., the largest and smallest representative non-verbal symbols should be determined.

The features of the scale 502 include the dollar amount of the area of the scale as the dollar amount of a single dimension of the scale. Also, representative colors can be provided by the scale. All colors can be shown on the scale at once or a single color can be shown and the scale enabled to change color to show a user what each color represents.

The placement of each non-verbal symbol on the storyboard is significant in that it signifies something about the underlying business metric. For example, the closer to the top of the storyboard that a non-verbal symbol is placed the newer the asset, liability, sale, etc. Or, the farther to the left that a non-verbal symbol is placed the more accessed the asset, liability, customer list, or other business metric. In some embodiments of the present subject matter no verbal means whatsoever will be used on a storyboard; however, something similar to an x-y scale can be added to the storyboard to help a user understand the significance of the non-verbal symbol's placement on the storyboard.

This system can be used in an operating system such as Windows or Mac, but can also be used without employing a computing device. Also, the system can be stored on a central server. A user can enter the financial statement information into the system from a remote location, electronically (via secure transfer) or manually forward the financial statement information to the central server location, and then the central server can transform the information into a color accounting sheet either for immediate electronic transfer back to the user or for placement in a secured storage device.

As the present system is one that enables a user to view a business metric without verbiage, the system can be configured to depict the overall vitality of the business, i.e., whether the company is in the red or black. The equity square 408 of FIG. 4 can be configured with a particular color, shape, size or other indicator to show that the company is profitable.

I claim:

1. A system for comparatively displaying values using non-verbal means, the system recorded on a non-transitory medium and comprising:
an identification component for identifying a first metric having a first value and a second metric having a second value;
a processor configured to select a respective first and second non-verbal symbol to represent each of the first metric and the second metric and to calculate a size of each non-verbal symbol based on the values of the first and second metrics; and
a high definition output means for displaying the non-verbal symbols, each of the non-verbal symbols having a single dimension that is divisible by a common denominator;
wherein the processor is further configured to create, and display on the high definition output means, a non-verbal reference symbol and a reference value associated with the reference symbol that represents the relationship of the first and second values to the size of the non-verbal symbols.

2. A system for comparatively displaying values using non-verbal means as recited in claim 1, wherein the non-verbal symbol has a form selected from the group consisting of: a circle, an oval, an asymmetric figure, a square, a triangle, a three-dimensional figure and a polygon.

3. A system for comparatively displaying values using non-verbal means as recited in claim 2, wherein the non-verbal symbol is a computer screen icon used for accessing information about a business metric.

4. A system for comparatively displaying values using non-verbal means as recited in claim 3,
wherein the output means is bifurcated depicting on a first side thereof a use field and depicting on a second side thereof a source field,
wherein each field includes one of the first metric or the second metric, the first metric representing an asset and the second metric representing a liability, and
wherein the assets and liabilities are obtained from a traditional financial statement

5. A system for comparatively displaying values using non-verbal means as recited in claim 4, further comprising an equity non-verbal symbol having a form identical to the first and second non-verbal symbols.

6. A system for comparatively displaying values using non-verbal means as recited in claim 5, wherein the first and second metrics are selected from the group consisting of: profit, equity, assets, liabilities, profit per employee, market capitalization, return on assets, earnings per share, price, price per and earnings.

7. A system for comparatively displaying values using non-verbal means as recited in claim 1, wherein the first and second metrics are selected from the group consisting of: profit, equity, assets, liabilities, profit per employee, market capitalization, return on assets, earnings per share, price, price per and earnings.

8. A system for comparatively displaying values using non-verbal means as recited in claim 1, wherein the output means is selected from the group consisting of: a display screen, a tactile device, an olfactory device, a print-out, and a speaker.

9. A method of comparatively displaying values using non-verbal means, the method comprising:
identifying a first metric having a first value and a second metric having a second value;
selecting a respective non-verbal symbol to represent each of the first metric and the second metric and calculating a size of each non-verbal symbol based on the values of the first and second metrics; and
displaying on a high definition output means the non-verbal symbols, each of the non-verbal symbols having a single dimension that is divisible by a common denominator;
creating, and displaying on the high definition output means, a non-verbal reference symbol and a reference value associated with the reference symbol that represents the relationship of the first and second values to the size of the non-verbal symbols.

10. A method of comparatively displaying values using non-verbal means as recited in claim 9, further comprising selecting a form for each of the non-verbal symbols from a group consisting of: a circle, an oval, an asymmetric figure, a square, a triangle, a three-dimensional figure and a polygon.

11. A method of comparatively displaying values using non-verbal means as recited in claim 10, wherein the non-verbal symbol is a computer screen icon for accessing information about a business metric.

12. A method of comparatively displaying values using non-verbal means as recited in claim 11,
wherein the output means is bifurcated depicting on a first side thereof a use field and depicting on a second side thereof a source field,
wherein each field includes one of the first metric or the second metric, the first metric representing an asset and the second metric representing a liability, and
wherein the assets and liabilities are obtained from a traditional financial statement

13. A method of comparatively displaying values using non-verbal means as recited in claim 12, further comprising selecting an equity non-verbal symbol having a form identical to the first and second non-verbal symbols.

14. A method of comparatively displaying values using non-verbal means as recited in claim 13, further comprising selecting the first and second metrics from a group consisting of: profit, equity, assets, liabilities, profit per employee, market capitalization, return on assets, earnings per share, price, price per and earnings.

15. A method of comparatively displaying values using non-verbal means as recited in claim 9, further comprising selecting the first and second metrics from a group consisting of: profit, equity, assets, liabilities, profit per employee, market capitalization, return on assets, earnings per share, price, price per and earnings.

16. A method of comparatively displaying values using non-verbal means as recited in claim 9, further comprising selecting the output means from a group consisting of: a display screen, a tactile device, an olfactory device, a print-out, and a speaker.

17. A three dimensional structure representing entries on a financial statement comprising,
a base having a fulcrum, a supporting structure overlying the fulcrum and a center dividing line for dividing the supporting structure into a first side and a second side,
a use object for placement on the first side of the supporting structure and a source object for placement on the second side of the supporting structure when a use object is placed on the first side of the supporting structure
wherein the size of the use and source objects corresponds to use and source entries on a balance sheet and the weight of the use and source objects are adjustable based on the size of the respective use and source entries on the balance sheet and wherein proper placement of both use and source objects on the supporting structure at the same time results in the supporting structure being level about its' fulcrum.

18. A three dimensional structure as recited in claim 17, wherein the source object is comprised of at least one item selected from the group consisting of: a liability sub-block and an equity sub-block.

19. A three dimensional structure as recited in claim 18, wherein the equity sub-block is comprised of an item selected from the group consisting of an income, sub-block and an expense sub-block.
